(19) United States
(12) Patent Application Publication
(10) Pub. No.: US 2011/0052075 A1
(43) Pub. Date: Mar. 3, 2011

(54) REMOTE RECEIPT ANALYSIS

(76) Inventors: OFER COMAY, Tel Aviv (IL); PAZ KAHANA, Newton, MA (US); VITALIY KHODKEVICH, Tel Aviv (IL)

(21) Appl. No.: 12/873,040

(22) Filed: Aug. 31, 2010

Related U.S. Application Data
(60) Provisional application No. 61/275,449, filed on Aug. 31, 2009.

(51) Int. Cl. G06K 9/46; G06K 7/10

(52) U.S. Cl. 382/190; 382/321

(57) ABSTRACT

A computer implemented method performs remote receipt analysis. The method includes receiving an image of a receipt over a network and automatically performing optical character recognition on the image of the receipt to obtain a machine-encoded text. The method further includes automatically extracting data which includes an amount paid from the machine-encoded text and automatically generating a message based on the data and sending the message to a user device.

### CROSS REFERENCE TO RELATED APPLICATIONS

The present invention claims the priority benefit of U.S. provisional patent application No. 61/275,449 filed on Aug. 31, 2009, which is incorporated in its entirety herein by reference.

### FIELD OF THE INVENTION

The present invention relates to network based applications. More particularly, the present invention relates to a method and system for providing remote receipt analysis over a network.

### BACKGROUND OF THE INVENTION

Document capture has traditionally referred to a capability of scanning or digitizing a paper document for electronic storage in a computer system. For example, the digitized document may be entered as part of a database. In general, a system that performs such tasks, often referred to as a document management system, is based on an individual computer of on a networked system. With the advent of Internet-based technology, it has become possible to construct a document management system that can store data via a website.

A document management system typically enables indexing the documents or otherwise enables organization of the stored documents. For example, organization of the documents may enable retrieving a document as needed. For example, indexing or document retrieval may be based on key words that are associated with a document.

Digitization of documents may also be employed in order to extract data from the documents. For example, content of a document may be added to a database where data from the content may be available for further processing or analysis.

Optical character recognition (OCR) technology is often used to extract data from a document. For example, application of OCR technology may convert a digitized image of a document to text or symbols. Typically, application of an OCR program yields an OCR text that is a close approximation to the original text. However, the OCR text typically includes errors that may result from images that the OCR program failed to correctly identify, or that the OCR program identified in an ambiguous manner. A human user typically must compare the OCR text with the original document to check or verify the accuracy of the OCR text, and correct as needed. Both the running of the OCR program and accuracy checking by a human user may be time consuming tasks.

In addition, a document may include features that may present additional difficulties to OCR. For example, a simple OCR program may not be capable of interpreting handwritten text, text containing unusual symbols or fonts, or text written or printed on a non-uniform background. However, a sophisticated OCR program capable of overcoming these difficulties may be expensive, or otherwise difficult for a typical user to obtain or run.

Once a reliable OCR text is obtained, data may be extracted from the OCR text and applied to various applications.

It is an object of the present invention to provide a network based system and method of analyzing a document provided by a remote user, and for incorporating data extracted from the document to provide information needed by the user.

Other aims and advantages of the present invention will become apparent after reading the present invention and reviewing the accompanying drawings.

### SUMMARY OF THE INVENTION

There is thus provided, in accordance with some embodiments of the present invention, a computer implemented method for remote receipt analysis. The method includes: receiving an image of a receipt over a network; automatically performing optical character recognition on the image of the receipt to obtain a machine-encoded text; automatically extracting data which includes an amount paid from the machine-encoded text; and automatically generating a message based on the data and sending the message to a user device.

Furthermore, in accordance with some embodiments of the present invention, the message includes an expense report.

Furthermore, in accordance with some embodiments of the present invention, the extracted data includes identification of an issuer.

Furthermore, in accordance with some embodiments of the present invention, the extracted data includes identification of a product.

Furthermore, in accordance with some embodiments of the present invention, the message includes a price comparison.

Furthermore, in accordance with some embodiments of the present invention, automatically generating a message includes querying a database of products and prices.

Furthermore, in accordance with some embodiments of the present invention, the method includes soliciting input from an operator.

There is further provided, in accordance with some embodiments of the present invention, a computer program product stored on a non-transitory tangible computer readable storage medium for remote receipt analysis, the computer program including code for receiving an image of a receipt over a network; automatically performing optical character recognition on the image of the receipt to obtain a machine-encoded text; automatically extracting data which includes an amount paid from the machine-encoded text; and automatically generating a message based on the data and sending the message to a user device.

Furthermore, in accordance with some embodiments of the present invention, the message includes an expense report.

Furthermore, in accordance with some embodiments of the present invention, the extracted data includes identification of an issuer.

Furthermore, in accordance with some embodiments of the present invention, the extracted data includes identification of a product.

Furthermore, in accordance with some embodiments of the present invention, the message includes a price comparison.

Furthermore, in accordance with some embodiments of the present invention, the code for automatically generating a message includes code for querying a database of products and prices.

Furthermore, in accordance with some embodiments of the present invention, the computer program product includes code for soliciting input from an operator.

There is further provided, in accordance with some embodiments of the present invention, a data processing system including: a processor; and a computer usable medium connected to the processor, wherein the computer usable medium contains a set of instructions for remote receipt analysis, wherein the processor is designed to carry out a set of instructions to: receive an image of a receipt over a network; automatically perform optical character recognition on the image of the receipt to obtain a machine-encoded text; automatically extract data which includes an amount paid from the machine-encoded text; and automatically generate a message based on the data and send the message to a user device.

Furthermore, in accordance with some embodiments of the present invention, the message includes an expense report.

Furthermore, in accordance with some embodiments of the present invention, the extracted data includes identification of an issuer.

Furthermore, in accordance with some embodiments of the present invention, the extracted data includes identification of a product.

Furthermore, in accordance with some embodiments of the present invention, the message includes a price comparison.

Furthermore, in accordance with some embodiments of the present invention, the instructions to automatically generate a message include instructions to query a database of products and prices.

Furthermore, in accordance with some embodiments of the present invention, the code includes instructions to solicit input from an operator.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1 is a schematic diagram of a remote receipt analysis system in accordance with embodiments of the present invention.

FIG. 2 shows a flowchart illustrating a method for remote receipt analysis, in accordance with embodiments of the present invention.

### DETAILED DESCRIPTION OF EMBODIMENTS

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Aspects of the present invention, as may be appreciated by a person skilled in the art, may be embodied in the form of a system, a method or a computer program product. Similarly, aspects of the present invention may be embodied as hardware, software or a combination of both. Aspects of the present invention may be embodied as a computer program product saved on one or more computer readable medium (or mediums) in the form of computer readable program code embodied thereon.

For example, the computer readable medium may be a computer readable signal medium or a computer readable non-transitory storage medium. A computer readable storage medium may be, for example, an electronic, optical, magnetic, electromagnetic, infrared, or semiconductor system, apparatus, or device, or any combination thereof.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer program code in embodiments of the present invention may be written in any suitable programming language. The program code may execute on a single computer, or on a plurality of computers.

Aspects of the present invention are described hereinabove with reference to flowcharts and/or block diagrams depicting methods, systems and computer program products according to embodiments of the invention.

A system for remote document analysis, in accordance with embodiments of the present invention, provides a remote system for analysis of a document image submitted by an appropriate user device. The document typically includes a receipt for an amount paid for one or more products or services. For example, a user may photograph or scan the document with an appropriate user device to which the user has access. For example, the user may photograph a document using a digital camera that is incorporated into a mobile telephone. The user may then send the digital photograph from the mobile telephone to a remote processing center via a network. For example, the user may use an email or Internet function of the mobile to send the digital photograph to the remote processing center. The user device may be programmed with an appropriate user program. For example, the user program may be configured to transmit the document image to an appropriate processing center.

Alternatively, the user device may include a digital camera that is connectable to a computer, or to a webcam or scanner that is connected to the computer. The user may then use an email or Internet function of the computer to transmit the image to the remote processing center. Alternatively, the user may use a facsimile machine or other telephone-based image transmission device to transmit an image of the document to the remote processing center.

A user device may be configured to transmit any required identification or other data required by the processing center for appropriate subsequent processing of the submitted document. For example, such data may include a user name, one or more user identification numbers or codes, a current location of the user device, method of payment, credit card number, or a date and time. Other information required by the processing center may be stored in a database maintained by the processing center. Alternatively, the information may be submitted by the user device in association with the document image. For example, a program running on the user device may prompt the user to enter the information. Alternatively, the information may be stored on a memory unit associated with the user device. Programming required for interacting with the processing center may be installed on the user device, or may be accessible by the user device via a network.

The processing center may include one or more processing units. For example, each processing unit may include a computer, or a plurality of intercommunicating computers, that is programmed to perform one or more processing tasks. The processing unit may be configured to receive a transmitted document image.

A processing unit at the processing center may apply various processing techniques to a received document image. For example, the processing unit may apply one or more image enhancement or image adjustment techniques in order to obtain an image suitable for further processing. The processing unit may apply OCR technology in order to identify text or other content of the document image. Application of OCR technology may then result in machine encoded text. For example, the machine encoded text may include one or more strings of text characters. A human operator at the processing center may review the results in order to verify correct interpretation of the OCR results, or to provide any required human input. For example, the human operator may select a correct result from several possibilities, or provide an interpretation for unidentifiable characters.

A processing unit may perform additional analysis of a document image. For example, the processing unit may extract data from OCR results. The processing unit may, for example, add the extracted data to a database, use the extracted data to query a database, may store the data in a retrievable manner, or may use the data as input to a program or application.

Typically, the processing unit may extract an amount paid from the OCR results. For example, the processing unit may be configured to recognize an amount paid by identifying text that is typically positioned adjacent to a number representing an amount paid.

Typically, as a result of analysis of the document image, the processing unit may generate a message and send it to a destination user device. The destination user device may be identical with, or associated with, the user device from which the document image was submitted, or may be a different device.

For example, an expense report module, in accordance with some embodiments of the present invention, may be included in a processing unit. The expense report module may be configured to create an expense report on the basis of one or more document images.

For example, a subscriber to an expense report service may operate a client program on a user device. The user device may be configured to submit an image of a receipt for a payment that is to be included in the expense report.

For example, an expense report module of a processing unit may be configured to recognize text that represents an amount paid, or a component of an amount paid. In addition, the expense report module may be configured to distinguish among various components of the amount paid. For example, the expense report module may be configured to distinguish between an expense that is refundable or tax-deductible, and one that is not.

The expense report module may generate an expense report based in part upon the receipt data. For example, an expense report may also include any identifying or other information that may be associated with the expense report. Such information may include information that is stored in a database that is associated with the expense report module. Alternatively, the information may be transmitted by a user device in association with the image of the receipt.

The expense report module may generate an expense report whenever a document image, or set of document images, is received. Alternatively or in addition, the expense report module may store any received data and generate an expense report at a predetermined time. For example, the expense report module may generate a weekly, monthly, or annual expense report at predetermined dates. As another example, the expense report module may generate an expense report at the end of a business trip or meeting. The end of a business trip may be indicated by a scheduled return date. Alternatively, a user operating a user device may transmit a message or signal to the expense report module at the beginning and end of the business trip or meeting.

The expense report module may send the expense report as a message to a device associated with the user who submitted the document image. Alternatively or in addition, the expense report module may send the expense report to a designated recipient (e.g. an accountant or accounting department).

A processing unit, in accordance with some embodiments of the present invention, may include a household management module. For example, a user may subscribe to a household management service. A household management module may analyze a received image of document and extract data from the document. For example, a user device may transmit an image of a store receipt to a processing unit that includes a household management module. The household management module may identify on the receipt image such information as: a name and location of a store, a date of purchase, products purchased, and the price of each product.

A household management module in accordance with embodiments of the present invention, may maintain a database of products and prices at various stores. For example, information from a received receipt image may be added to the database as the information is acquired. A received receipt image may also be used to query the database. For example, a query to the database based on information from the receipt image may be used to compare prices. For example, the household management module may send to a user a listing or sum of what the same products would have cost if purchased at another store. The query may be limited to a particular geographical area. For example, the query may be limited to stores in a limited geographical area near the store that issued the receipt. Such a query may help the user select a store for future purchases. On the other hand, the query may include stores in a wide geographical region so as to enable regional comparisons of prices. The results of the query, such as a price comparison, may be sent to the user or a user device in the form of a message.

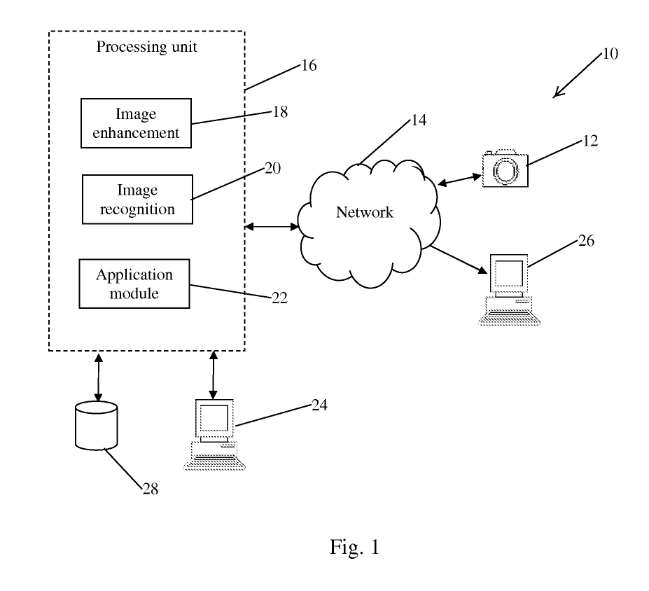

FIG. 1 is a schematic diagram of a remote receipt analysis system in accordance with embodiments of the present invention. Receipt analysis system 10 includes user device 12 that may communicate with a processing unit 16 via network 14. User device 12 may include a digital imaging device in combination with a device capable of transmitting a digital image over network 14. For example, image acquisition device may include a digital camera or a scanner that may communicate with a computer, a fax machine, or a mobile telephone or other mobile communications device with a built-in camera. Network 14 may include, for example, a wired or wireless telephone network, a wired or wireless computer network, or the Internet.

Processing unit 16 may be typically located at a remote processing center. For example, a remote processing center may be maintained by remote document analysis provider. Processing unit 16 may represent a single processor or computer, or a plurality of intercommunicating processors or computers. A remote document analysis provider may provide one or more remote document analysis services. Each of the various services may be provided on a separate processing unit 16. Alternatively, a single processing unit 16 may be configured to provide several remote data analysis services. A processing unit 16 may be configured to provide service to a single group of users, for example, users that are associated with a single organization. Alternatively, processing unit 16 may be configured to provide service to several groups of users.

Processing unit 16 may be configured to perform a variety of functions. Each of these functions may be represented schematically as separate modules of processing unit 16. Each module may represent a separate processor or computer, or to various programming or software units that operate on a single processor. For example, each module may represent a program or subprogram.

Processing unit 16 may include an image enhancement module 18. Image enhancement module 18 may be configured to perform one or more image enhancement functions. For example, image enhancement module 18 may be configured to distinguish between printed text and a background, may adjust image brightness, contrast, or sharpness in order to facilitate text recognition, and may correct for distortion of the image.

Processing unit 16 may include an image recognition module 20. Image recognition module 20 may be configured to perform one or more image recognition operations on a document image. The image recognition operations may include, for example, OCR. Image recognition operations may also include recognizing a type of document, and identifying particular data within the document. For example, a document recognition operation may include identifying a title of the document and classifying the document on the basis of the text content of the identified title. Identification of particular data may include identifying text on the basis of its position within the document, or on its proximity to a key word. For example, a total amount paid may be identified as text in currency format that appears at a particular location in the document (e.g. lowermost on the document, or at the top of or at the bottom of column of prices), that is distinguished from other text (e.g. larger font size or bold type); that appears in a particular context (e.g. next to the word “total” or “amount paid”), or text that meets the best combination of these criteria. Image recognition operations may include recognizing an itemized list of purchased items and their prices, and an amount of sales tax or value added tax paid. For example, a list may be recognized as a vertical column of text in currency format appearing next to an aligned column of text in the form of verbal descriptions (e.g. being recognized as a list of products or services) or Universal Product Code (UPC) numbers. Image recognition operations may also include recognizing a receipt date as text in date format. When several dates appear in the receipt, the most appropriate date may be selected using criteria such as location on the receipt image, or a keyword that appears near the date. Image recognition may also recognize the vendor, typically using a database of vendor information (including, e.g. vendor names, logos, addresses, or phone numbers).

Image recognition module 20 may interact with operator console 24. Operator console 24 may enable a human operator to review results of image recognition module 20. For example, operator console 24 may include one or more output devices, such as a display screen, printer, or speaker, and one or more input devices, such as a keyboard, mouse, trackball, touch-sensitive screen, pointer, or joystick. Operator console 24 may also enable a human operator to provide human input when required. For example, automatic running of image recognition module 20 may fail to identify text or information regarding a document, or may lead to an ambiguous result. In such cases, human input via operator console 24 may enable correct interpretation of a submitted document image.

Processing unit 16 may include one or more application modules 22. Each application module 22 may be configured to perform one or more operations associated with an application of remote receipt analysis system 10. An application module 22 may be configured to provide operations for an application such as expense report preparation, workflow management, or household management. For example, an application to be run may be selected on the basis of user input that is submitted from user device 12 in association with a submitted document image. Alternatively, an application may be selected on the basis of user subscription information. Alternatively, an application may be selected on the basis of a recognized property of the document. For example, a receipt that is identified as being associated with travel or business expenses may automatically activate an expense report application. On the other hand, a receipt identified as an itemized receipt from a food or department store may automatically activate a household management application. Automatic selection of an application may be subject to verification by a user via user device 12, or by an operator via operator console 24.

An application module 22 may communicate with a data storage device 28. Data storage device 28 may represent a single storage device, such as a hard disk, or a plurality of data storage devices that may be accessed by processing unit 16. For example, a data storage device 28 may include one or more databases. An application module 22 may add data that was extracted from a submitted document to a database on data storage device 28. Alternatively, an application module 22 may use extracted data to query a database on data storage device 28. For example, a household management application may add price data from a submitted shopping receipt to a database, or query the database in order to find a price for the same product at another store. As another example, data may be transferred to a service provider that provides accounting, auditing, expense reporting, or other financial services.

Typically, an application module 22 may generate a result. For example, an expense report application may generate an expense report. As another example, a household management module may generate comparative price information. Such comparative information may include: a list of prices at other stores, the location of a store with lower prices, or notification of a current sale or promotional campaign. The comparative price information may relate to a geographic location, or to a product or class of products. Typically, processing unit 16 may transmit a result generated by an application module 22 as a message via network 14 to a user console 26. User console 26 may be identical to, or associated with, user device 12, or it may be a separate device. A generated result may be sent to user console 26, or a user operating user console 26 may access a generated result via network 14. For example, when a result is generated, processing unit 16 may send a notification to user console 26.

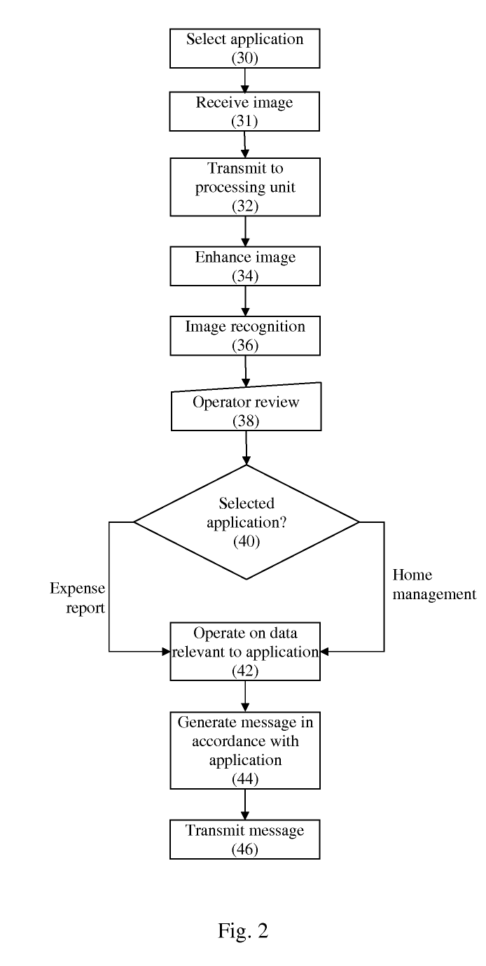

FIG. 2 shows a flowchart illustrating a method for remote receipt analysis, in accordance with embodiments of the present invention. It should be understood that the division of the method into individual steps is for convenience only, and that alternative division into steps may be possible with equivalent results. Also, the order of the steps is for illustration purposes only. Steps of the method may be performed concurrently or in another order with equivalent results. The various alternative divisions of the method into steps, and the various alternative orders of the steps, should be considered as included within the scope of the present invention.

Reference is also made to components of the remote receipt analysis system shown in FIG. 1.

The user may operate user device 12 to indicate to processing unit 16 via network 14 an application to be run on a captured document image (step 30). A user operating user device 12 may capture an image of a receipt or document (step 31). For example, processing unit 16 may communicate with user device 12 or operator console 24 so as to solicit input regarding selection of an application (e.g. during a login process). The user may select an application from a set of applications that are available to the user. For example, available applications may depend on one or more document properties (e.g. title, content), on user status (e.g. business or private, or type of subscription). Alternatively, an application may be selected automatically based on document properties (e.g. after steps 32 through 36), or manually by a system operator selection. Automatic selection of an application may be subject to confirmation by a user or operator. Operator selection may be subject to confirmation by the user.

Processing unit 16 may receive via network 14 the captured document image as submitted by user device 12 (step 32). Processing unit 16 may apply image enhancement operations of image enhancement module 18 to the submitted document image (step 34). For example, application of image enhancement operations may determine which regions of the document image, if any, require image enhancement. For example, image enhancement may render one or more regions of the document image more amenable to interpretation by image recognition module 20.

Processing unit 16 may apply one or more recognition operations of image recognition module 20 to the submitted document image (step 36). For example, recognition operations may include OCR to convert at least part of the image into one or more text strings. Recognition operations may also include identification of a type of data represented by one or more of the text strings. Typically, recognition operations include identifying a text string that represents an amount paid, receipt date, vendor name, or a list of products or services with their itemized prices. OCR operations may be applied to a document as a whole, without consideration of what information is to be extracted. Alternatively, at least some of the recognition operations may be applied in accordance with the selected application. In this case, application of the recognition operations may be directed toward extracting particular data from the document. For example, if an expense report application is selected and the identified document is a receipt, recognition operations (and perhaps image enhancement operations) may be limited to one or more regions of interest of the receipt. For example, the recognition operations may be limited to extracting an amount paid and identification of a vendor.

When image recognition module 20 is unable to extract all required data from the document image, processing unit 16 may solicit input from a human operator via operator console 24. Alternatively, a document image and image recognition results may be submitted to operator console 24 for verification as a routine matter under a variety of predetermined conditions (e.g. type of document, type of application, user provided importance ranking). A human operator may then input corrections or verification via operator console 24 (step 38).

An application module 22 may, on the basis of a selected operation (step 40) operate on recognized data in a manner appropriate to the selected application (step 42).

For example, if an expense report application was selected, an expense report application may extract relevant data from the submitted document. Such relevant data may include identification of the issuer of the receipt, a transaction date, item or service purchased, amount paid, and amount of tax paid. The expense report application may communicate with data storage device 28 in order to receive information such as, for example, approved types of expenditures, and usual price ranges.

If a household management application was selected, a household management application may extract relevant data from the submitted document. Such relevant data may include: identification of store in which purchases were made, products purchased, prices paid, and date of purchase. The household management application may communicate with data storage device 28 in order to store the data in an appropriate database, or to query the database to determine such information as, for example, the prices for similar products at another store.

An application module 22, upon operation on extracted data, may generate an appropriate result (step 44). The type of result may depend on the selected application. Typically, the result is in the form of a message to be sent to a user console 26 (step 46).

For example, if an expense report application was selected, the result may include a generated expense report. Alternatively, if an expense report is to be generated at a future date, the expense report application may store the relevant data on data storage device 28. When the expense report is generated, processing unit 16 may transmit a notification to user console 26 via network 14. For example, user console 26 may be associated with an accounting department.

If a household management application was selected, the result may include a price comparison. For example, a user may be prompted to select, e.g. via user console 26, one or more itemized items on the receipt for a price comparison. In this case, a table or other data structure that includes price comparison information may be generated. The generated price comparison information may be transmitted as a message to user console 26. User console 26 may be identical with user device 12.

It should be clear that the description of the embodiments and attached Figures set forth in this specification serve only for a better understanding of the invention, without limiting its scope.

It should also be clear that a person skilled in the art, after reading the present specification could make adjustments or amendments to the attached Figures and above described embodiments that would still be covered by the present invention.

1. A computer implemented method for remote receipt analysis, the method comprising:
receiving an image of a receipt over a network;
automatically performing optical character recognition on the image of the receipt to obtain a machine-encoded text;
automatically extracting data which includes an amount paid from the machine-encoded text; and
automatically generating a message based on the data and sending the message to a user device.

2. A method as claimed in claim 1, wherein the message comprises an expense report.

3. A method as claimed in claim 1, wherein the extracted data comprises identification of an issuer.

4. A method as claimed in claim 1, wherein the extracted data comprises identification of a product.

5. A method as claimed in claim 4, wherein the message comprises a price comparison.

6. A method as claimed in claim 5, wherein automatically generating a message comprises querying a database of products and prices.

7. A method as claimed in claim 1, comprising soliciting input from an operator.

8. A computer program product stored on a non-transitory tangible computer readable storage medium for remote receipt analysis, the computer program including code for receiving an image of a receipt over a network;
automatically performing optical character recognition on the image of the receipt to obtain a machine-encoded text;
automatically extracting data which includes an amount paid from the machine-encoded text; and
automatically generating a message based on the data and sending the message to a user device.

9. A computer program product as claimed in claim 8, wherein the message comprises an expense report.

10. A computer program product as claimed in claim 8, wherein the extracted data comprises identification of an issuer.

11. A computer program product as claimed in claim 8, wherein the extracted data comprises identification of a product.

12. A computer program product as claimed in claim 11, wherein the message comprises a price comparison.

13. A computer program product as claimed in claim 12, wherein the code for automatically generating a message comprises code for querying a database of products and prices.

14. A computer program product as claimed in claim 8, comprising code for soliciting input from an operator.

15. A data processing system comprising:
a processor; and
a computer usable medium connected to the processor, wherein the computer usable medium contains a set of instructions for remote receipt analysis, wherein the processor is designed to carry out a set of instructions to:
receive an image of a receipt over a network;
automatically perform optical character recognition on the image of the receipt to obtain a machine-encoded text;
automatically extract data which includes an amount paid from the machine-encoded text; and
automatically generate a message based on the data and send the message to a user device.

16. A data processing system as claimed in claim 15, wherein the message comprises an expense report.

17. A data processing system as claimed in claim 15, wherein the extracted data comprises identification of an issuer.

18. A data processing system as claimed in claim 15, wherein the extracted data comprises identification of a product.

19. A data processing system as claimed in claim 18, wherein the message comprises a price comparison.

20. A data processing system as claimed in claim 19, wherein the instructions to automatically generate a message comprise instructions to query a database of products and prices.

21. A data processing system as claimed in claim 15, comprising instructions to solicit input from an operator.
